(19) United States
(12) Patent Application Publication
(10) Pub. No.: US 2021/0089887 A1
(43) Pub. Date: Mar. 25, 2021

(54) Variance-Based Learning Rate Control For Training Machine-Learning Models

(71) Applicant: Apple Inc., Cupertino, CA (US)

(72) Inventors: Tyler B. Johnson, Sunnyvale, CA (US); Carlos E. Guestrin, Seattle, WA (US); Pulkit Agrawal, Seattle, WA (US); Haijie Gu, Seattle, WA (US)

(21) Appl. No.: 16/832,934

(22) Filed: Mar. 27, 2020

Related U.S. Application Data
(60) Provisional application No. 62/904,915, filed on Sep. 24, 2019.

(51) Int. Cl. G06N 3/08

(52) U.S. Cl. CPC G06N 3/08

(57) ABSTRACT

A method includes determining a training scale for training a machine-learning model, defining a group of worker nodes having a number of worker nodes that is selected according to the training scale, and determining an average gradient of a loss function during a training iteration using the group of worker nodes. The method also includes determining a variance value for the average gradient of the loss function, determining a gain ratio based on the variance value for the average gradient of the loss function, and determining a learning rate parameter based on a learning rate schedule and the gain ratio. The method also includes determining updated parameters for the machine-learning model using the learning rate parameter and the average gradient of the loss function.

### CROSS-REFERENCE TO RELATED APPLICATIONS

This application claims the benefit of U.S. Provisional Application No. 62/904,915 filed on Sep. 24, 2019, the content of which is hereby incorporated by reference herein in its entirety for all purposes.

### TECHNICAL FIELD

This disclosure relates to variance-based learning rate control for training machine-learning models.

### BACKGROUND

Large datasets and large models underlie much of the recent success of machine learning. In a neural network, conventional training techniques optimize the weights of processing elements (e.g., neurons) such that loss is minimized. Training typically includes a large number of training iterations. Loss is calculated for each training iteration and used as a basis for optimization. A commonly used optimization technique is stochastic gradient descent (SGD), which is an iterative method that can be used to optimize a neural network or other objective function. SGD is a type of gradient descent optimization in which the gradient is estimated based on a random sampling of data instead of computing the actual gradient from the entire data set. The parameters (e.g., weights) of the neural network are updated based on the slope and direction of the gradient.

Training large machine-learning models is time consuming, however, as SGD algorithms can require days or weeks to train effectively. Thus, procedures that speed up SGD enable consideration of more data and models, which expands the capabilities of machine learning. To speed up SGD, distributed systems can process thousands of training examples per iteration. But training at large scales also creates an algorithmic challenge. Specifically, learning rates must adapt to each scale. Without choosing these training parameters carefully, scaled SGD frequently produces low-quality models, resulting in a waste of resources rather than an efficient technology.

To adapt learning rates, fixed scaling rules are standard but unreliable strategies. One technique, known as linear learning rate scaling, can work well, especially for computer vision tasks. For other problems or larger scales, however, linear scaling often fails. Other fixed scaling rules are also undependable. Previous work has compared linear scaling, root scaling, and identity scaling, and concluded that each one often degrades model quality. Another approach recommends computing parameters for particular tasks and scales without adherence to any fixed rule, which is inconvenient and resource intensive.

### SUMMARY

One aspect of the disclosure is a method that includes determining a training scale for training a machine-learning model, defining a group of worker nodes having a number of worker nodes that is selected according to the training scale, and determining an average gradient of a loss function during a training iteration using the group of worker nodes. The method also includes determining a variance value for the average gradient of the loss function, determining a gain ratio based on the variance value for the average gradient of the loss function, and determining a learning rate parameter based on a learning rate schedule and the gain ratio. The method also includes determining updated parameters for the machine-learning model using the learning rate parameter and the average gradient of the loss function.

In some implementations, the gain ratio is determined by interpolating between a minimum gain ratio value and a maximum gain ratio value based on the variance value for the average gradient of the loss function. In some implementations, the minimum gain ratio value is equal to one and the maximum gain ratio value is based on the training scale. In some implementations, the minimum gain ratio value is equal to one and the maximum gain ratio value is equal to the number of worker nodes in the group of worker nodes.

In some implementations, the training iteration includes performing, by each worker node from the group of worker nodes, sampling a mini-batch from training samples, determining a mini-batch loss by processing the mini-batch using the machine-learning model, and determining an individual gradient of the loss function based on the mini-batch loss.

The method may also include transmitting an initial version on the machine-learning model to each worker node from the group of worker nodes prior to a first training iteration. The method may also include transmitting the updated parameters for the machine-learning model to each worker node from the group of worker nodes.

Another aspect of the disclosure is a non-transitory determiner-readable storage device including program instructions executable by one or more processors that, when executed, cause the one or more processors to perform operations. The operations include determining a training scale for training a machine-learning model, defining a group of worker nodes having a number of worker nodes that is selected according to the training scale, and determining an average gradient of a loss function during a training iteration using the group of worker nodes. The method also includes determining a variance value for the average gradient of the loss function, determining a gain ratio based on the variance value for the average gradient of the loss function, and determining a learning rate parameter based on a learning rate schedule and the gain ratio. The method also includes determining updated parameters for the machine-learning model using the learning rate parameter and the average gradient of the loss function.

Another aspect of the disclosure is a system that includes program instructions and one or more processors that are operable to execute the program instructions. The program instructions, when executed by the one or more processors, cause the one or more processors to determine a training scale for training a machine-learning model, define a group of worker nodes having a number of worker nodes that is selected according to the training scale, and determine an average gradient of a loss function during a training iteration using the group of worker nodes.

The program instructions further cause the one or more processors to determine a variance value for the average gradient of the loss function, determine a gain ratio based on the variance value for the average gradient of the loss function, and determine a learning rate parameter based on a learning rate schedule and the gain ratio. The program instructions further cause the one or more processors to determine updated parameters for the machine-learning model using the learning rate parameter and the average gradient of the loss function.

### BRIEF DESCRIPTION OF THE DRAWINGS

FIG. 1 shows a scaled stochastic gradient descent function.

FIG. 2 shows a gradient computation function.

FIG. 3 shows an adaptive scaled stochastic gradient descent function.

FIG. 4 is a block diagram that shows a distributed training system.

FIG. 5 is a block diagram that shows a worker of the distributed training system.

FIG. 6 is a flowchart that shows an example of a process for distributed training of a machine-learning model with variance-based learning rate control.

FIG. 7 is a flowchart that shows an example of a gradient computation process.

FIG. 8 is an illustration that shows an example of a hardware configuration for a computing device.

### DETAILED DESCRIPTION

The description herein relates to a variance-based learning rate control technique for training machine-learning models. A deep neural network is an example of a machine-learning model. Deep neural networks include processing elements, referred to as neurons, that are related to each other by learnable parameters (e.g., weights for each neuron).

The systems and methods described herein control the learning rate by adapting to the variance of the gradient during SGD. Since decreased gradient variance is the fundamental impact of large batch sizes, scaling provides little gain if the variance is already small at small scales. In such cases, the learning rate is increased conservatively, and training progresses similarly to the small-batch setting. For iterations with large gradient variance, the learning rate is increased aggressively, and the progress from each update increases dramatically.

The systems and methods described herein are approximately scale invariant, which significantly simplifies large-batch training. With no changes to learning rates or other inputs, training quality may be preserved across many scales using a simple learning rate schedule and no arbitrary heuristics.

Training large machine-learning models is typically performed using distributed training methods in which the training task is split so that it is performed by multiple computing devices (e.g., graphics processing units), which are referred to as worker nodes or workers. There may be a very large number of workers.

Distributed training can be implemented using model parallelism, in which the neural network is split across multiple worker nodes, or using data parallelism, in which each worker uses a different mini-batch sampled from a training data set to train the same model. The description herein is made with respect to distributed training systems that use data parallelism.

In the description herein, worker nodes are controlled by a parameter server. Other types of distributed training architectures can be used. The parameter server stores a master copy of the deep learning model. The parameter server provides each worker with a copy of the deep learning model, and provides updates to the parameters (e.g., weights) of the model at each iteration based on updated received from the worker nodes.

The workers each sample a mini-batch of training data from a training data set and determines an individual update by computing a gradients for its mini-batch. Parameter updates are communicated by each worker as individual updates that are transmitted to the parameter server. The parameter server combines the individual updates and computes a master update that describes the changes to the deep learning model. The master update is transmitted to the workers and includes the new parameters for the deep learning model.

During training the scale can be changed by the parameter server. The scale controls the number of the workers that are used at each training iteration. The learning rate is also changed during training in response to changes in the scale. The learning rate controls the amount by which the parameters are modified in each training iteration.

The systems and methods that are described herein are applicable to training a machine-learning model, such as a deep neural network. Training a machine-learning model is performed by optimizing parameters for the machine-learning model over multiple training iterations. For example, training may be performed by computing approximate solutions to the problem shown in Equation 1.

[symbol]

F(w), where F(w)= [symbol] _{x˜X}[ƒ(w,x)] (1)

In Equation 1, parameters w represent the parameters of a machine-learning model, while X denotes a distribution over batches of training data. A loss function ƒ is assumed to be differentiable with respect to w. Thus, the problem represented in Equation 1 is that of minimizing the error produced by applying the loss function to the model.

Stochastic gradient descent (SGD) is commonly applied to solve the problem shown in Equation 1. Let parameters wₜ denote the model parameters when iteration t begins. During iteration t, SGD samples a batch xₜ˜X and computes a gradient gₜ←∇_{w}ƒ(wₜ,xₜ). SGD then applies the update wₜ₊₁←wₜ−ηₜgₜ. Here, a learning rate parameter ηₜ is the learning rate that will be applied in iteration t. Given a learning rate schedule lr: [symbol] _{≥0}→ [symbol] _{>0}, we define ηₜ=lr(t), which means that the learning rate parameter ηₜ for iteration t is a function of the learning rate schedule lr, conditioned on the iteration number. As an example, the learning rate schedule lr may be a function, such as an exponential decay function or step decay function.

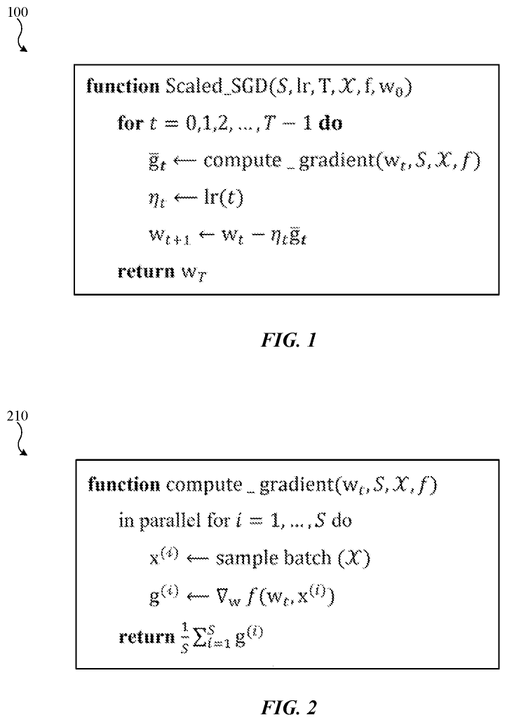

To speed up training, practitioners often parallelize gradient computation across multiple devices, which may be referred to as distributed training. FIG. 1 shows a scaled stochastic gradient descent (SGD) function 100, which is an example that implements well-known techniques for scaling SGD. A scale S describes the number of workers that will be used to compute the gradient at each iteration. At scale S, the scaled SGD function 100 samples S independent batches during each iteration. After computing the gradient for each batch in parallel, the algorithm applies the mean of these gradients (in place of the gradient gₜ) when updating model parameters.

In the scaled SGD function 100, the inputs are the scale S, the learning rate schedule lr, a training length T (e.g., expressed as a total number of training iterations), training data X (which may be represented as a probability distribution over batches of training data), a loss function f, and an initial model w₀. The scaled SGD function 100 is iterative. The pseudocode statement for t=0, 1, 2, . . . , T−1 do indicates that iterations of the following instructions are performed until reaching the limit set according to the training length T. In each iteration the gradient is computed by the workers, the learning rate for the current iteration is updated, and the model is updated according to the gradients computed by the workers and the learning rates. The pseudocode statement g̅ₜ←compute_gradient(wₜ,S,X,ƒ) indicates that a function is used to compute the average gradient g̅ₜ for a current model wₜ using workers of a number according to the scale S, the training data X, and the loss function ƒ, as will be described further herein. The pseudocode statement ηₜ←lr(t) means that the learning rate parameter ηₜ for iteration t is a function of the learning rate schedule lr, conditioned on the iteration number. In the pseudocode statement wₜ₊₁←wₜ←ηₜg̅ₜ, an updated model wₜ₊₁ is computed based on the average gradient g̅ₜ, the learning rate parameter ηₜ, and the current model wₜ, here by scaling the average gradient g̅ₜ by the learning rate parameter ηₜ and applying the scaled average gradient to the current model wₜ (e.g., by backpropagation). Once all iterations are completed, a final model w_{T} is output by the scaled SGD function 100.

FIG. 2 shows a gradient computation function 210 that is an implementation of the compute_gradient function that is used in the scaled SGD function 100. The inputs are the current model wₜ, the scale S, the training data X, and the loss function ƒ. A group of workers having a number set according to the scale S all perform operations in parallel. The pseudocode statement x⁽ⁱ⁾←sample batch (X) indicates that each worker samples a respective mini-batch x⁽ⁱ⁾ from the training data X. The pseudocode statement g⁽ⁱ⁾←∇_{w}ƒ(wₜ, x⁽ⁱ⁾) indicates that each worker determines a respective gradient g⁽ⁱ⁾ by applying the loss function ƒ to evaluate the results obtained by the current model wₜ in processing the mini-batch x⁽ⁱ⁾. The return statement indicates that the respective gradients g⁽ⁱ⁾ that are determined by the workers are averaged and returned to the calling function, for example, as the average gradient g̅ₜ in the scaled SGD function 100.

Scaling training in the manner described in the scaled SGD function 100 requires a new learning rate schedule for each scale. The systems and methods address this with the variance-based learning rate control technique, which is approximately scale invariant. In the context of scaled SGD algorithms, the algorithm is scale invariant if the final model does not depend on the scale S that was used during training. A scale-invariant algorithm accommodates parallelization of training by scaling to any available amount of computational resources with parameter retuning, use of unreliable heuristics, or algorithmic expertise from users.

Fixed scaling rules have previously been applied to the scaled SGD algorithms such as the scaled SGD function 100. Examples of fixed scaling rules include identity scaling and linear learning rated scaling.

Identity scaling keeps the training configuration constant for all scales by using the same learning rate schedule lr and the same training length T for all scales S. Identity scaling is inefficient because it does not reduce the number of training iterations.

Linear learning rate scaling scales the learning rate schedule up according to the scale S and scales the number of training iterations down according to the scale S. For example, linear learning rate scaling can be applied according to lr(t)=S·lr_{S1}(St) and T=[T_{S1}/S] where lr_{S1} represents the learning rate schedule for S=1 and T_{S1} represents the total number of training iterations for S=1.

Linear learning rate scaling treats SGD as a perfectly parallelizable algorithm. If true, applying gradients from S batches in parallel achieves the same result as doing so in sequence. The variance-based learning rate control technique recognizes that SGD using linear learning rate scaling is not scale invariant. Instead performance learning rate scaling is dependent on the variance of the gradient. Identity scaling performs ideally when the variance of the gradient is zero. Linear scaling leads to scale-invariance in the case of very large gradient variance (as well as small learning rates and many iterations, to compensate for this variance).

In practice, the gradient's variance is neither zero nor infinite, and both identity and linear scaling may perform poorly. Moreover, the gradient's variance does not remain constant throughout training. Thus, as will be explained herein, the variance-based learning rate control technique is configured to continually adapt to the state of training.

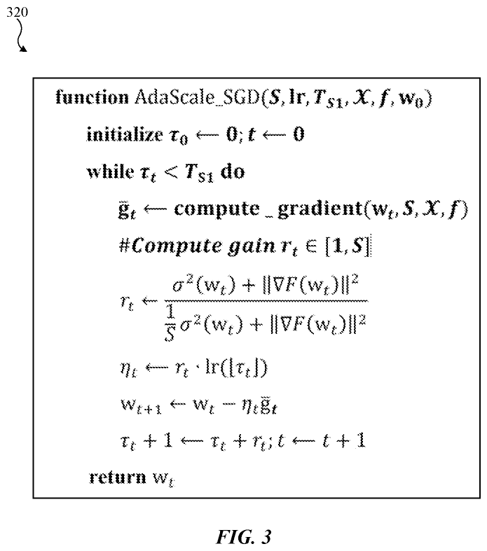

FIG. 3 shows an adaptive scaled stochastic gradient descent (SGD) function 320, also referred to as AdaScale SGD, which is an implementation of the variance-based learning rate control technique. In the adaptive scaled SGD function 320, the inputs are the scale S, the learning rate schedule lr, a training length T_{S1} (e.g., expressed as a total number of training iterations for S=1), training data X (which may be represented as a probability distribution over batches of training data), the loss function ƒ, and the initial model w₀. Variables are initialized at zero for tracking a current iteration t and for tracking a scaled iteration count τ₀.

The adaptive scaled SGD function 320 is iterative. The pseudocode statement while τₜ<T_{S1} do indicates that iterations of the following instructions are performed until the scaled iteration count τ_{T} reaches the limit set according to the training length T_{S1}. The scaled iteration count τₜ is a scale-invariant representation of the number of iterations that have been completed. The scaled iteration count τₜ may be defined as τₜ=Σ_{t′=0}^{t-1}r_{t′}. The scaled iteration count τₜ represents the fact that scaling increases the amount of progress made per iteration, and models this by assuming that iteration t performs the equivalent of rₜ single-batch iterations. The scaled iteration count τₜ is a variable that is used to accumulate and track this progress. The adaptive scaled SGD function concludes training when τₜ≥T_{S1}. Where T_{S1} is the total iterations when S=1.

In each iteration the gradient is computed by the workers, a gain rate is determined, the learning rate for the current iteration is updated using the gain rate, the model is updated according to the gradients computed by the workers and the learning rates, and the scaled iteration count τₜ is updated. As will be explained, the scaled iteration count is updated in a manner that accounts for scaling to represent the amount of progress made toward completion of the training process.

The pseudocode statement g̅ₜ←compute_gradient(wₜ,S,X,ƒ) indicates that a function is used to compute the average gradient g̅ₜ for a current model wₜ using workers of a number according to the scale S, the training data X, and the loss function ƒ. In the example implementation, the gradient computation function 210 is used.

The pseudocode statement ηₜ←rₜ·lr(└τₜ┘) means that the learning rate parameter ηₜ for iteration t is a function of the learning rate schedule lr, conditioned on the scaled iteration count τₜ, which is scaled by the gain ratio rₜ. The gain ratio rₜ adjusts the learning rate parameter ηₜ for iteration t to account for scaling, as will be described herein.

In the pseudocode statement wₜ₊₁←wₜ−ηₜg̅ₜ, an updated model wₜ₊₁ is computed based on the average gradient g̅ₜ, the learning rate parameter ηₜ, and the current model wₜ, here by scaling the average gradient g̅ₜ by the learning rate parameter ηₜ and applying the scaled average gradient to the current model wₜ (e.g., by backpropagation). After the model is updated, the scaled iteration count τₜ is updated in dependence on the gain ratio, for example, according to the expression τₜ+1←τₜ+rₜ. The iteration t is incremented, for example, according to the expression t←t+1.

Once all iterations are completed, a final model w_{T} is output by the adaptive scaled SGD function 320.

In the adaptive scaled SGD function 320, the gain ratio rₜ adjusts the learning rate parameter ηₜ to account for scaling based on the variance of the gradient. This adjustment is an adaptive interpolation between identity scaling and linear learning rate scaling based on σ² (wₜ). During iteration t, AdaScale multiplies the learning rate by the “gain ratio” rₜ∈[1,S]:ηₜ=rₜ·lr(└τₜ┘)

The identity scaling rule and the linear scaling rule correspond to two special cases of the adaptive scaled SGD function 320. If rₜ=1 for all t, the algorithm equates to SGD with identity scaling. Similarly, if rₜ=S for all t, we have linear scaling. To approximate linear scaling the gain ratio rₜ is set between one and S based on the gradient's variance. The gain ratio rₜ is set approximately equal to one when the gradient's variance is very small the gain ratio rₜ is set approximately equal to S when the gradient's variance is large. To interpolate the gain ratio between one and S based on the gradient's variance, given wₜ, the gain ratio rₜ is defined as follows in Equation 2, where σ² (wₜ) is the variance of the gradient and ∥∇_{F}(wₜ)∥² is the magnitude of the gradient.

$${r}_{t} = \frac{( {σ}^{2} ( {w}_{t} ) + {‖ ∇ F ( {w}_{t} ) ‖}^{2} )}{( \frac{1}{S} {σ}^{2} ( {w}_{t} ) + {‖ ∇ F ( {w}_{t} ) ‖}^{2} )} \qquad ( 2 )$$

Relative to single-batch training, the gain ratio rₜ also ensures that the quantities [symbol] [ [symbol] (ηₜg̅ₜ, ∇F(wₜ) [symbol] ] and [symbol] [∥ηₜg̅ₜ∥²] increase multiplicatively by rₜ.

In practice, the gain ratio rₜ cannot be calculated directly. Instead, the gain ratio rₜ may be determined by estimating the gain ratio rₜ. If S=1, then rₜ=1 for all iterations. For larger scales, rₜ depends on σ² (wₜ) and ∥∇Fwₜ∥², and a practical implementation must efficiently approximate these values. Fortunately, the per-batch gradients gₜ⁽¹⁾, . . . , gₜ^{(S)} and aggregated gradient g̅ₜ are readily available in distributed SGD algorithms. Estimating rₜ may be performed according to Equations 3 and 4:

$$\begin{matrix}{\hat{σ}}_{t}^{2} = \frac{1}{S - 1} {\sum }_{i = 1}^{S} {‖ {g}_{t}^{( i )} ‖}^{2} - \frac{S}{S - 1} {‖ {\overline{g}}_{t} ‖}^{2} & ( 3 ) \\ {\hat{μ}}_{t}^{2} = {‖ {\overline{g}}_{t} ‖}^{2} - \frac{1}{S} {\hat{σ}}_{t}^{2} & ( 4 )\end{matrix}$$

Here, \hat{σ}ₜ² and \hat{μ}ₜ² are unbiased estimates of σ²(wₜ) and ∥∇F(wₜ)∥². To ensure robustness to estimation variance, we define σ̅ₜ² and μ̅ₜ² as exponential moving averages of \hat{σ}ₜ² and \hat{μ}ₜ² over prior iterations. An averaging parameter θ=max{1−S/1000,0} may be used, where θ=0 results in no averaging. To initialize, we define r₀←1, and for iterations t<(1−θ)⁻¹, we define σ̅ₜ² and μ̅ₜ² as the mean (not exponentially weighted) of past samples. Before averaging, we also clip \hat{σ}ₜ² and \hat{μ}ₜ² so that \hat{σ}ₜ²>10⁻⁶ (to prevent division by zero) and \hat{μ}ₜ²≥0 (to ensure rₜ∈[1,S]).

Momentum techniques are commonly used to increase the speed of convergence in training a machine-learning model using SGD, and is applicable to the systems and methods that are described herein. Given a parameter ρ∈[0, 1], momentum-SGD initializes state m₀←0 and applies the updates according to:

mₜ₊₁←μmₜ+gₜ and wₜ₊₁←wₜ−ηₜmₜ₊₁ (5)

The parameter ρ could be adapted to each scale and iteration when incorporating momentum. However, the performance of momentum-SGD, however, depends less critically on the parameter ρ than the learning rate. The influence of the parameter ρ will vary in dependence on characteristics of the model, and it has been found that the systems and methods described herein often performs well if the parameter ρ remains constant across scales and iterations.

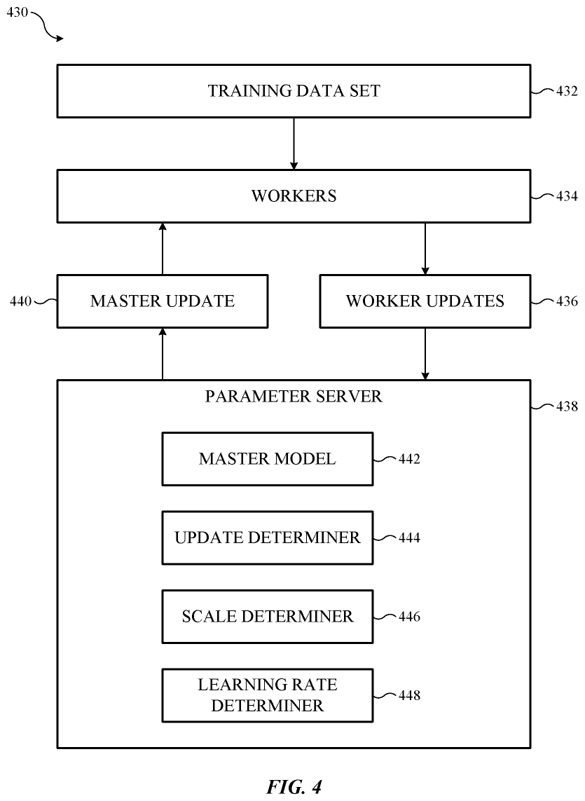

FIG. 4 is a block diagram that shows a distributed training system 430. The distributed training system 430 includes a training data set 432, workers 434 that determine worker updates 436, a parameter server 438 that receives the worker updates 436 and determines a master update 440 that is transmitted to the workers 434. The workers 434 are computing devices, such as graphics processing units, and may also be referred to as worker nodes. The parameter server 438 includes a master model 442, which is a deep learning model such as a deep neural network. The parameter server 438 also includes an update determiner 444, which determines the master update 440 based on the worker updates 436. For example, the update determiner 444 may set the master update 440 equal to an average of the worker updates 436.

The parameter server 438 also includes a scale determiner 446 and a learning rate determiner 448. The scale determiner 446 determines the number of the workers 434 to be used during each training iteration. For example, the scale may be represented by a variable that is equal to the number of workers that are being used to compute an update to the model in a particular training iteration. Various methods may be used to control scale. As one example, the scale may be predetermined and may remain fixed across all training iterations. As another example, the scale may be controlled by a predetermined schedule that sets the number of workers to be used for each training iteration. As another example, the scale may be controlled according to a function that is conditioned on one or more variables that are associated with training.

The learning rate determiner 448 determines a learning rate to be used during each training iteration. The learning rate controls the amount by which the parameters of the deep learning model are modified during each training iteration. The learning rate determiner 448 uses the variance-based learning rate control technique for calculating the learning rate as will be described further herein.

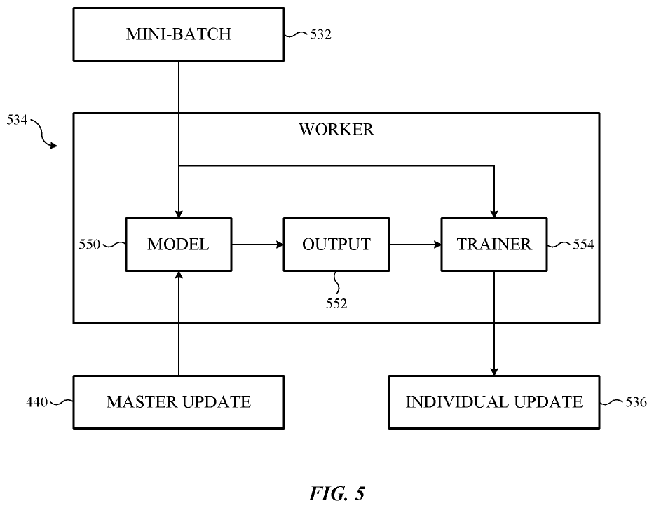

FIG. 5 is a block diagram that shows a worker 534, which is one of the workers 434 of the distributed training system 430. The worker 534 is a computing device, and may also be referred to as a worker node. The worker 534 samples a mini-batch 532 from the training data set 432. The worker 534 determines an individual update 536, which is transmitted to the parameter server 438, and receives the master update 440 from the parameter server 438. The worker 534 includes a model copy 550 that generates output 552, which is provided to a trainer 554, along with the mini-batch 532 (e.g., including ground truth information for computing loss). The trainer 554 uses optimization techniques to determine the individual update 536, which is one of the worker updates 436, and includes updates to the model copy 550 based on the output 552. For example, a loss function is used to determine losses based a comparison of the output 552 and the ground truth information from the mini-batch 532. The losses are used to determine the current slope of a gradient according to stochastic gradient descent. The gradient is used to update the parameters of the deep learning model in the individual update 536.

The amount by which the parameters of the deep learning model are changed in the individual update based on the gradient in is controlled by the learning rate. In the illustrated example, the learning rate is determined by the learning rate determiner 448 of the parameter server 438 based on the master model 442. In an alternative implementation, the learning rate determiner 448 of the parameter server 438 may be omitted, and an equivalent learning rate determiner may be included in each of the workers 534 which would each calculate the learning rate independently at each training iteration.

The individual update 536 from each of the workers 534 is transmitted to the parameter server 438. The master update 440 is determined based on the individual updates 536, for example, by averaging as previously described. The master update 440 is then sent to each of the workers 534. Upon receiving the master update 440, the worker 534 updates the model copy 550 using the updated parameters that are included in the master update 440.

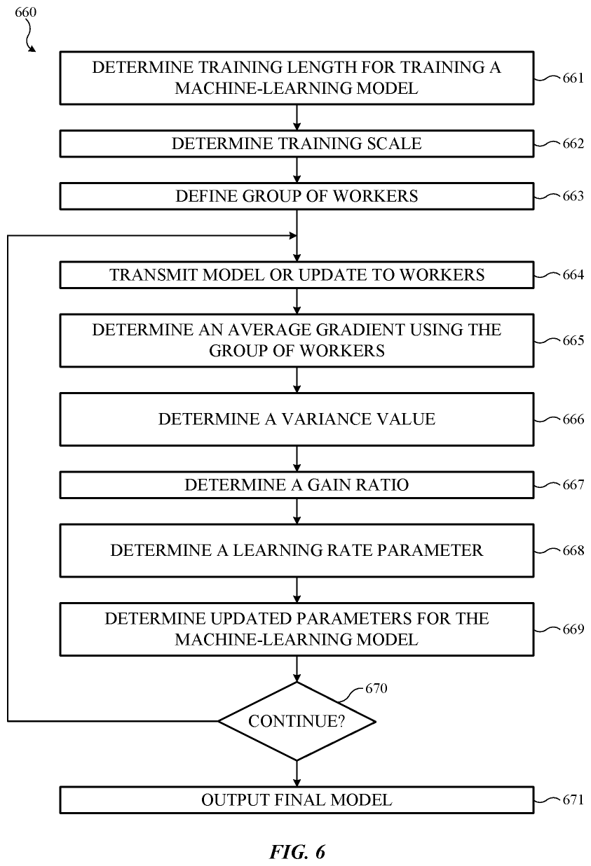

FIG. 6 is a flowchart that shows an example of a process 660 for distributed training of a machine-learning model with variance-based learning rate control. The process 660 may be implemented in accordance with the description of the gradient computation function 210, the adaptive scaled SGD function 320, and the training system 430. The description of the gradient computation function 210, the adaptive scaled SGD function 320, and the training system 430, along with their various inputs, outputs, and components is incorporated by reference in the description of the process 660.

The process 660 may be implemented using a computing device. As one example, a computing device may include one or more processors, one or more memory devices, and computer-interpretable instructions that are stored in the one or more memory device and accessible to the one or more processors, wherein the instructions, when executed by the one or more processors, cause the one or more processors to perform the operations of the process 660. In some implementations, the process 660 is implemented in the form of a non-transitory computer-readable storage medium that includes computer-interpretable program instructions that cause operation of the process 660 by one or more processors when executed.

Operation 661 includes determining a training length for training a machine-learning model. The training length may be specified as a number of iterations. This number of iterations may reflect a number of iterations to be performed when the training scale is equal to one, meaning that only one computing device is used for training. During training, the actual number of iterations may be tracked. A scale-invariant representation of the number of training iterations performed may also be tracked to represent the progress made by distributed training as compared to training using a single computing device. The scale-invariant representation may be implemented in the manner described with respect to the scaled iteration count Tₜ, which is a scale-invariant representation of the number of iterations that have been completed.

Operation 662 includes determining a training scale for training the machine-learning model. The training scale may be expressed as a number of computing devices to be used for training or may be expressed in another form. The training scale may be a predetermined value that remains fixed during training. The training scale may change during training, for example, according to a schedule or function.

Operation 663 includes defining a group of workers having a number of workers that is selected according to the training scale. As one example, the number of workers can be set equal to the training scale. As another example, the number of workers can be set according to the training scale according to any type of relationship that can be used to determine the number of workers according to the training scale, such by using a training scale expressed as a percentage of available workers to determine the number of workers in the group of workers.

Operation 664 includes transmitting a copy of the machine-learning model or an update to the machine-learning model to workers. Prior to a first training iteration, operation 664 may include transmitting an initial version on the machine-learning model to each worker from the group of workers. Between training iterations, the current model or information usable to update the model may be transmitted to the workers. As one example, operation 664 may include transmitting the updated parameters for the machine-learning model to each worker from the group of workers between training iterations. As another example, operation 664 may include transmitting an updated copy of the machine-learning model to each worker from the group of workers between training iterations. Thus, in the implementations discussed herein, the workers use identical copies of the machine learning model for each training iteration. Accordingly, in operation 664, information is transmitted to the workers that provides each worker with an updated copy of the model to use during the next training iteration.

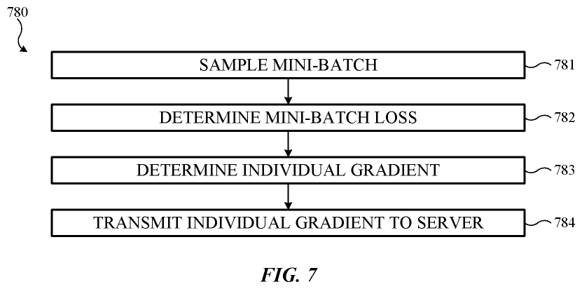

Operation 665 includes determining an average gradient of a loss function during a training iteration using the group of workers. An example of a gradient computation process 770 that can be utilized to determine the average gradient of the loss function will be described further herein with reference to FIG. 7.

Operation 666 includes determining a variance value for the average gradient of the loss function. The variance value may be estimated, for example, as discussed with respect to the adaptive scaled SGD function 320.

Operation 667 includes determining a gain ratio based on the variance value for the average gradient of the loss function. The gain ratio may be determined, for example, as discussed with respect to the adaptive scaled SGD function 320.

The gain ratio may be determined in operation 667 by interpolating between a minimum gain ratio value and a maximum gain ratio value based on the variance value for the average gradient of the loss function that was determined in operation 666. As an example, the minimum gain ratio value may be equal to one and the maximum gain ratio value may be based on the training scale. As an example, the minimum gain ratio value may be equal to one and the maximum gain ratio value may be equal to the number of workers in the group of workers.

Operation 668 includes determining a learning rate parameter based on a learning rate schedule and the gain ratio. The learning rate parameter may be determined, for example, as discussed with respect to the adaptive scaled SGD function 320. As an example, an unscaled learning rate value may be determined from the learning rate schedule based on the current training iteration number or based on the scaled iteration count τₜ. The unscaled learning rate value represents a learning rate value to be used when the scale is equal to one. The unscaled learning rate value is modified by the gain ratio, for example by multiplying the unscaled learning rate value by the gain ratio, to determine the learning rate parameter.

Operation 669 includes determining updated parameters for the machine-learning model using the learning rate parameter and the average gradient of the loss function. The updated parameters may be determined, for example, as discussed with respect to the adaptive scaled SGD function 320. The learning rate parameter is used to determine the magnitude of the adjustment to be made to the machine-learning model, as previously discussed.

Operation 670 includes determining whether training should be continued by performing additional training iterations. For example, determining whether training should be continued can include incrementing the iteration number and the scaled iteration count τₜ, and then comparing the scaled iteration count τₜ to the training length that was established in operation 661.

If more training iterations will be performed, the process 660 returns to operation 664. If no further training iterations will be performed, the process 660 proceeds to operation 671.

In operation 671, a final version of the model is output. The final version of the model is a trained machine-learning system that is configured to perform a specific task according to the training that was performed. The tasks that the trained model may be applied to include all of those to which machine-learning models are commonly applied, such as information processing, object detection, scene understanding, and content generation.

FIG. 7 is a flowchart that shows an example of a process 780 for gradient computation. The process 780 may be implemented in accordance with the description of the gradient computation function 210. The description of the gradient computation function 210 along with its various inputs, outputs, and components is incorporated by reference in the description of the process 780.

The process 780 may be implemented using a computing device. As one example, a computing device may include one or more processors, one or more memory devices, and computer-interpretable instructions that are stored in the one or more memory device and accessible to the one or more processors, wherein the instructions, when executed by the one or more processors, cause the one or more processors to perform the operations of the process 780. In some implementations, the process 780 is implemented in the form of a non-transitory computer-readable storage medium that includes computer-interpretable program instructions that cause operation of the process 780 by one or more processors when executed.

The process 780 is a training operation that is performed by all workers once per iteration. For example, the process 780 may be used in the process 660 as an implementation of operation 665.

Operation 781 includes sampling a mini-batch from training samples. The training samples may be consistent with the description of the training data set 432. Sampling from the mini-batch may be implemented in accordance with the description of the mini-batch 532, for example, by random sampling.

Operation 782 includes determining a mini-batch loss by processing the mini-batch using the machine-learning model. As previously described, the mini-batch is processed by the machine-learning model, resulting in an output. The output of the machine learning model is evaluated using the loss function, for example, by comparison of the output to ground truth values. The resulting value obtained from the loss function is the mini-batch loss.

Operation 783 includes determining an individual gradient of the loss function based on the mini-batch loss. The individual gradient is the gradient computed by one of the workers based on the mini-batch loss using an optimization, which is stochastic gradient descent in this example.

In operation 784 the individual gradient is transmitted to the server that is coordinating the efforts of the workers. The parameter server 438 is an example of such a server. Upon receiving the individual gradients from all of the workers, the individual gradients are averaged by the server to define an average gradient, which is used to update the parameters of the machine-learning model prior to the next training iteration as previously described.

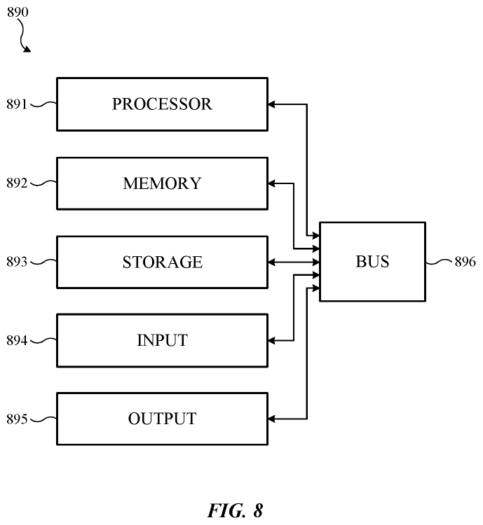

FIG. 8 is an illustration that shows an example of a hardware configuration for a computing device that can be used to implement the systems described herein. The computing device 890 may include a processor 891, a memory 892, a storage device 893, one or more input devices 894, and one or more output devices 895. The computing device 890 may include a bus 896 or a similar device to interconnect the components for communication. The processor 891 is operable to execute computer program instructions and perform operations described by the computer program instructions. As an example, the processor 891 may be or include one or more conventional processing devices of any type, such as a central processing unit, a field-programmable gate array, or an application specific integrated circuit. The memory 892 may be a volatile, high-speed, short-term information storage device such as a random-access memory module. The storage device 893 may be a non-volatile information storage device such as a hard drive or a solid-state drive. The input devices 894 may include any type of human-machine interface such as buttons, switches, a keyboard, a mouse, a touchscreen input device, a gestural input device, or an audio input device. The output devices 895 may include any type of device operable to provide an indication to a user regarding an operating state, such as a display screen or an audio output.

As described above, one aspect of the present technology is training machine-learning models to perform processing tasks. Training machine-learning models is typical performed using large datasets, and thus, training machine-learning models may include the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide personal information. In yet another example, users can select to limit the length of time that personal information is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
determining a training scale for training a machine-learning model;
defining a group of worker nodes having a number of worker nodes that is selected according to the training scale;
determining an average gradient of a loss function during a training iteration using the group of worker nodes;
determining a variance value for the average gradient of the loss function;
determining a gain ratio based on the variance value for the average gradient of the loss function;
determining a learning rate parameter based on a learning rate schedule and the gain ratio; and
determining updated parameters for the machine-learning model using the learning rate parameter and the average gradient of the loss function.

2. The method of claim 1, wherein the gain ratio is determined by interpolating between a minimum gain ratio value and a maximum gain ratio value based on the variance value for the average gradient of the loss function.

3. The method of claim 2, wherein the minimum gain ratio value is equal to one and the maximum gain ratio value is based on the training scale.

4. The method of claim 2, wherein the minimum gain ratio value is equal to one and the maximum gain ratio value is equal to the number of worker nodes in the group of worker nodes.

5. The method of claim 1, wherein the training iteration includes performing, by each worker node from the group of worker nodes:
sampling a mini-batch from training samples,
determining a mini-batch loss by processing the mini-batch using the machine-learning model, and
determining an individual gradient of the loss function based on the mini-batch loss.

6. The method of claim 1, further comprising
transmitting an initial version on the machine-learning model to each worker node from the group of worker nodes prior to a first training iteration.

7. The method of claim 1, further comprising
transmitting the updated parameters for the machine-learning model to each worker node from the group of worker nodes.

8. A non-transitory computer-readable storage device including program instructions executable by one or more processors that, when executed, cause the one or more processors to perform operations, the operations comprising:
determining a training scale for training a machine-learning model;
defining a group of worker nodes having a number of worker nodes that is selected according to the training scale;
determining an average gradient of a loss function during a training iteration using the group of worker nodes;
determining a variance value for the average gradient of the loss function;
determining a gain ratio based on the variance value for the average gradient of the loss function;
determining a learning rate parameter based on a learning rate schedule and the gain ratio; and
determining updated parameters for the machine-learning model using the learning rate parameter and the average gradient of the loss function.

9. The non-transitory computer-readable storage device of claim 8, wherein the gain ratio is determined by interpolating between a minimum gain ratio value and a maximum gain ratio value based on the variance value for the average gradient of the loss function.

10. The non-transitory computer-readable storage device of claim 9, wherein the minimum gain ratio value is equal to one and the maximum gain ratio value is based on the training scale.

11. The non-transitory computer-readable storage device of claim 9, wherein the minimum gain ratio value is equal to one and the maximum gain ratio value is equal to the number of worker nodes in the group of worker nodes.

12. The non-transitory computer-readable storage device of claim 8, wherein the training iteration includes performing, by each worker node from the group of worker nodes:
sampling a mini-batch from training samples,
determining a mini-batch loss by processing the mini-batch using the machine-learning model, and
determining an individual gradient of the loss function based on the mini-batch loss.

13. The non-transitory computer-readable storage device of claim 8, further comprising
transmitting an initial version on the machine-learning model to each worker node from the group of worker nodes prior to a first training iteration.

14. The non-transitory computer-readable storage device of claim 8, further comprising
transmitting the updated parameters for the machine-learning model to each worker node from the group of worker nodes.

15. A system, comprising:
program instructions; and
one or more processors that are operable to execute the program instructions, wherein the program instructions, when executed by the one or more processors, cause the one or more processors to:
determine a training scale for training a machine-learning model;
define a group of worker nodes having a number of worker nodes that is selected according to the training scale;
determine an average gradient of a loss function during a training iteration using the group of worker nodes;
determine a variance value for the average gradient of the loss function;
determine a gain ratio based on the variance value for the average gradient of the loss function;
determine a learning rate parameter based on a learning rate schedule and the gain ratio; and
determine updated parameters for the machine-learning model using the learning rate parameter and the average gradient of the loss function.

16. The system of claim 15, wherein the gain ratio is determined by interpolating between a minimum gain ratio value and a maximum gain ratio value based on the variance value for the average gradient of the loss function.

17. The system of claim 16, wherein the minimum gain ratio value is equal to one and the maximum gain ratio value is based on the training scale.

18. The system of claim 16, wherein the minimum gain ratio value is equal to one and the maximum gain ratio value is equal to the number of worker nodes in the group of worker nodes.

19. The system of claim 15, wherein during the training iteration the program instructions cause each worker node from the group of worker nodes to:
sample a mini-batch from training samples,
determine a mini-batch loss by processing the mini-batch using the machine-learning model, and
determine an individual gradient of the loss function based on the mini-batch loss.

20. The system of claim 15, wherein the program instructions further cause the one or more processors to:
transmit an initial version on the machine-learning model to each worker node from the group of worker nodes prior to a first training iteration; and
transmit the updated parameters for the machine-learning model to each worker node from the group of worker nodes.
